(19) United States
(12) Patent Application Publication
(10) Pub. No.: US 2026/0322127 A1
(43) Pub. Date: Oct. 15, 2026

(54) POWER CONSUMPTION REDUCTION SYSTEM, ELECTRICAL APPARATUS, AND METHOD OF REDUCING POWER CONSUMPTION

(71) Applicant: Mitsubishi Electric Corporation, Chiyoda-ku, Tokyo (JP)

(72) Inventor: Hajime IKEDA, Chiyoda-ku, Tokyo (JP)

(73) Assignee: Mitsubishi Electric Corporation, Chiyoda-ku, Tokyo (JP)

(21) Appl. No.: 19/483,810

(22) PCT Filed: Jul. 8, 2024
(86) PCT No.: PCT/JP2024/024623

§ 371 Date: Nov. 12, 2025

(30) Foreign Application Priority Data
Jul. 11, 2023 (JP) 2023-113591

(51) Int. Cl. H02J 3/14; H02J 13/12; H02J 13/14; H02J 13/182; H02J 105/42; H02J 105/52

(52) U.S. Cl. CPC H02J 3/14; H02J 13/12; H02J 13/14; H02J 13/182; H02J 2105/42; H02J 2105/52

(57) ABSTRACT

Provided are a power consumption reduction system, electrical apparatus, method of reducing power consumption, and program that can appropriately manage power consumptions without a dedicated control apparatus. A power consumption reduction system includes electrical apparatuses. The electrical apparatuses each include a power consumption acquirer to acquire a power consumption of the electrical apparatus, a power consumption index calculator to calculate a power consumption index, based on the operation state of the electrical apparatus, a transmitter to transmit the calculated power consumption index to another electrical apparatus, a receiver to receive the power consumption index of the other electrical apparatus, an operation amount calculator to calculate an operation amount for a controlled device when the calculated power consumption index exceeds the received power consumption index, based on the difference in power consumption index, and an operation controller to control operation of the controlled device.

### TECHNICAL FIELD

The present disclosure relates to a power consumption reduction system, an electrical apparatus, a method of reducing power consumption, and a program.

### BACKGROUND ART

Some techniques have been known for reducing power consumptions in electrical apparatuses. For example, Patent Literature 1 discloses an air-conditioning system that provides a power suppression command to some of the air conditioners, while dynamically changing the air conditioners to be provided with the power suppression command on the basis of the difference between the total electric power consumed by the air conditioners and a target value.

### CITATION LIST

### Patent Literature

Patent Literature 1: Unexamined Japanese Patent Application Publication No. 2020-124062

### SUMMARY OF INVENTION

### Technical Problem

Establishing this air-conditioning system requires a dedicated control apparatus. This dedicated control apparatus is applied to a control system, such as home energy management system (HEMS), and this control system may be incapable of controlling electrical apparatuses pursuant to different communication standards. The air-conditioning system thus finds it difficult to appropriately manage power consumptions of the electrical apparatuses, if the dedicated control apparatus cannot be provided to the network in the place of installation of the electrical apparatuses or cannot be connected to the electrical apparatuses.

An objective of the present disclosure, which has been accomplished in view of the above situation, is to provide a power consumption reduction system, an electrical apparatus, a method of reducing power consumption, and a program that can appropriately manage power consumptions without a dedicated control apparatus.

### Solution to Problem

In order to achieve the above objective, a power consumption reduction system according to the present disclosure includes electrical apparatuses configured to consume electric power. Each of the electrical apparatuses includes a power consumption acquirer to acquire a power consumption of the electrical apparatus, a power consumption index calculator to calculate, based on an operation state of the electrical apparatus, a power consumption index indicating a normalized value of the power consumption acquired by the power consumption acquirer, a transmitter to transmit, to another electrical apparatus, the power consumption index calculated by the power consumption index calculator, a receiver to receive a power consumption index of the other electrical apparatus, an operation amount calculator to calculate, based on a difference between the power consumption index calculated by the power consumption index calculator and the power consumption index received by the receiver, an amount of operation for a device to be controlled included in the electrical apparatus, when the power consumption index calculated by the power consumption index calculator is higher than the power consumption index received by the receiver, and an operation controller to control, based on the amount of operation calculated by the operation amount calculator, operation of the device to be controlled.

### Advantageous Effects of Invention

According to the present disclosure, when the power consumption index indicating a normalized value of the power consumption of the electrical apparatus is higher than the power consumption index of the other electrical apparatus, the electrical apparatus calculates an amount of operation for the device to be controlled included in the electrical apparatus, based on the difference between the own power consumption index and the power consumption index of the other electrical apparatus. The electrical apparatus then controls the operation of the device to be controlled, based on the calculated amount of operation. This system can therefore appropriately manage power consumptions without a dedicated control apparatus.

### BRIEF DESCRIPTION OF DRAWINGS

FIG. 1 illustrates a configuration of a power consumption reduction system according to Embodiment 1 of the present disclosure;

FIG. 2 is a block diagram illustrating a configuration of each of the electrical apparatuses illustrated in FIG. 1;

FIG. 3 illustrates exemplary operation state information indicating operation states of individual types of the electrical apparatuses illustrated in FIG. 1;

FIG. 4 illustrates exemplary controlled-device information indicating devices to be controlled of the individual types of the electrical apparatuses illustrated in FIG. 1;

FIG. 5 illustrates an exemplary variable map stored in each of the electrical apparatuses illustrated in FIG. 1;

FIG. 6 illustrates exemplary operation of a consensus algorithm;

FIG. 7 is a block diagram illustrating physical components of each of the electrical apparatuses illustrated in FIG. 1;

FIG. 8 is a flowchart illustrating a process of determining amounts of operation executed by each of the electrical apparatuses illustrated in FIG. 1;

FIG. 9 illustrates a configuration of an electrical apparatus according to Embodiment 2;

FIG. 10 is a flowchart illustrating a process of determining amounts of operation executed by the electrical apparatus according to Embodiment 2; and

FIG. 11 is a flowchart illustrating a process of determining amounts of operation executed by an electrical apparatus according to Modification 4.

### DESCRIPTION OF EMBODIMENTS

The following describes a power consumption reduction system, an electrical apparatus, a method of reducing power consumption, and a program according to embodiments of the present disclosure, with reference to the accompanying drawings.

### Embodiment 1

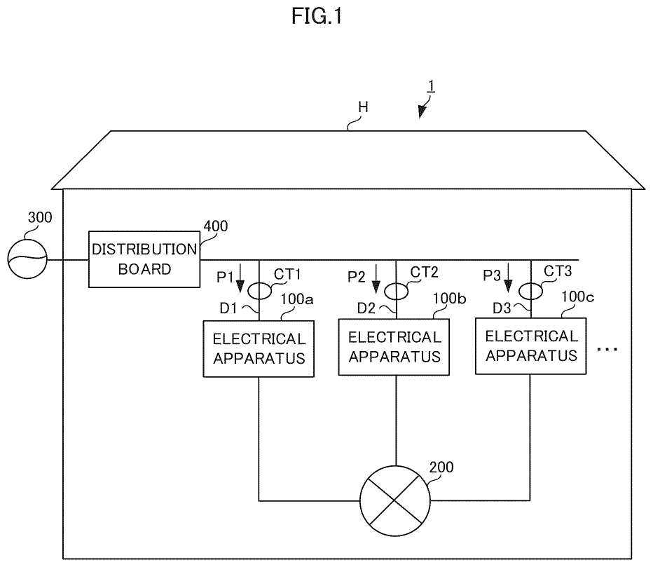

An electrical apparatus according to an embodiment of the present disclosure is described below, focusing on exemplary electrical apparatuses applied to a power consumption reduction system 1 illustrated in FIG. 1. As illustrated in the figure, the power consumption reduction system 1 includes electrical apparatuses 100 (electrical apparatuses 100a, 100b, 100c, . . . ) serving as electrical appliances installed in a house H. The electrical apparatuses 100 are connected via a network 200 so as to communicate with each other. The electrical apparatuses 100a, 100b, 100c, . . . are hereinafter collectively referred to as “electrical apparatuses 100” without distinction.

The electrical apparatuses 100 consume electric power in the house H.

Examples of the electrical apparatuses 100 include home appliances, such as induction heating (IH) cookers, induction cookers, laundry machines, televisions, and refrigerators, and facilities, such as air conditioners, water heaters, lighting devices, ventilation fans, electricity storage systems, floor heating systems, and central air-conditioning systems.

The electrical apparatuses 100a, 100b, 100c, . . . are respectively connected to power lines D1, D2, D3, . . . branching from a distribution board 400, and are driven by electric power fed from a commercial power grid 300. The electrical apparatus 100a is connected to a current transformer CT1 provided to the power line D1. The current transformer CT1 is a sensor that measures AC current. The electrical apparatus 100a acquires, via the current transformer CT1, a detected value of electric power P1 fed from the distribution board 400 to the electrical apparatus 100a. The electric power P1 corresponds to electric power consumed in the electrical apparatus 100a. The electrical apparatuses 100b and 100c are respectively connected to current transformers CT2 and CT3 provided to the respective power lines D2 and D3. The electrical apparatuses 100b and 100c acquire, via the current transformers CT2 and CT3, detected values of electric powers P2 and P3 fed from the distribution board 400 to the respective electrical apparatuses 100b and 100c. The electric powers P2 and P3 correspond to electric powers consumed in the respective electrical apparatuses 100b and 100c.

Each of the electrical apparatuses 100 in the power consumption reduction system 1 calculates a power consumption index indicating a normalized value of the power consumption of the electrical apparatus 100. The electrical apparatus 100 also acquires power consumption indexes of the other electrical apparatuses 100 capable of communication, from the other electrical apparatuses 100. Each of the electrical apparatuses 100 calculates amounts of operation for actuators included in the electrical apparatus 100, using a consensus algorithm that performs consensus control to converge the power consumption indexes of the electrical apparatuses 100 to a common value.

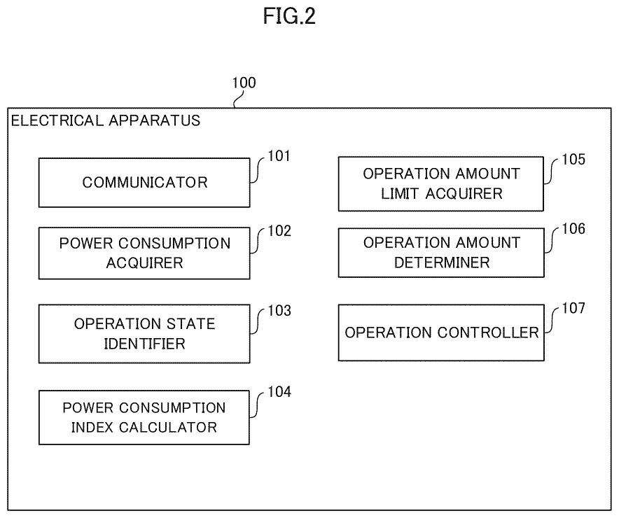

As illustrated in FIG. 2, the electrical apparatus 100 includes a communicator 101 that transmits and receives data to and from the other electrical apparatuses 100, a power consumption acquirer 102 that acquires the power consumption of the electrical apparatus 100, an operation state identifier 103 that identifies the operation state of the electrical apparatus 100, a power consumption index calculator 104 that calculates a power consumption index indicating a normalized value of the power consumption, an operation amount limit acquirer 105 that acquires the upper and lower limits of the amounts of operation for the actuators included in the electrical apparatus 100, an operation amount determiner 106 that determines the amounts of operation for the actuators included in the electrical apparatus 100, and an operation controller 107 that controls the actuators on the basis of the amounts of operation determined by the operation amount determiner 106.

The communicator 101 transmits and receives data to and from the other electrical apparatuses 100. Specifically, the communicator 101 transmits the power consumption index of the electrical apparatus 100 calculated by the power consumption index calculator 104, to the other electrical apparatuses 100 at predetermined time intervals. The communicator 101 receives the power consumption indexes of the other electrical apparatuses 100, from the other electrical apparatuses 100 at predetermined time intervals. The communicator 101 is an example of a receiver and a transmitter.

The power consumption acquirer 102 acquires the detected value of electric power consumed in the electrical apparatus 100. Specifically, the power consumptions in the electrical apparatuses 100a, 100b, 100c, . . . respectively correspond to the electric powers P1, P2, P3, . . . fed from the distribution board 400 via the respective power lines D1, D2, D3, . . . to the electrical apparatuses 100a, 100b, 100c, . . . . The power consumption acquirer 102 of the electrical apparatus 100a communicates with the current transformer CT1 provided to the power line D1, and acquires the value of the electric power P1 detected by the current transformer CT1. The power consumption acquirer 102 of the electrical apparatus 100b communicates with the current transformer CT2 provided to the power line D2, and acquires the value of the electric power P2 detected by the current transformer CT2. The power consumption acquirer 102 of the electrical apparatus 100c communicates with the current transformer CT3 provided to the power line D3, and acquires the value of the electric power P3 detected by the current transformer CT3.

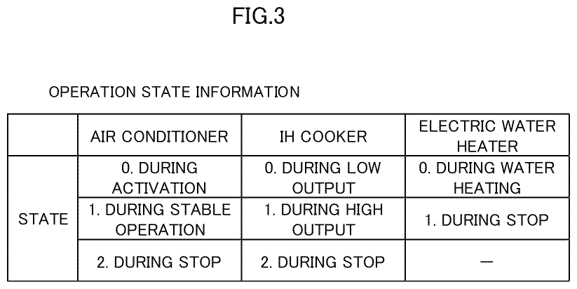

The operation state identifier 103 monitors the state of the electrical apparatus 100 at predetermined time intervals of one minute, ten minutes, or one hour, for example, and identifies the operation state of the electrical apparatus 100. Specifically, the operation state identifier 103 identifies the current state pursuant to predetermined rules, from among operation states defined in operation state information illustrated in FIG. 3 that indicates operation states of the individual types of electrical apparatuses 100. This function of the operation state identifier 103 is described in detail below.

Referring back to FIG. 2, the power consumption index calculator 104 calculates a power consumption index indicating a normalized value of the power consumption of the electrical apparatus 100. Specifically, the power consumption index calculator 104 calculates a power consumption index indicating the power consumption normalized to a range of 0 to 1, on the basis of the operation state of the electrical apparatus 100 identified by the operation state identifier 103. The power consumption index calculator 104 calculates a power consumption index using a power consumption index function f_{power consumption index function} (state) for obtaining a power consumption index on the basis of the identified operation state, represented by Expression (1) below.

f_{power consumption index function}(state)=P(t)/(Pₘₐₓ−Pₘᵢₙ)−Pₘᵢₙ/(Pₘₐₓ−Pₘᵢₙ) (1)

In Expression (1), P(t) indicates the detected value of the power consumption acquired by the power consumption acquirer 102, Pₘₐₓ indicates the maximum power consumption in the operation state of the electrical apparatus 100 identified by the operation state identifier 103, and Pₘᵢₙ indicates the minimum power consumption in the identified operation state of the electrical apparatus 100. The maximum power consumption Pₘₐₓ and the minimum power consumption Pₘᵢₙ are preliminarily defined for each type of electrical apparatus 100 and for each operation state of the electrical apparatus 100, by a manufacturer of the electrical apparatus 100.

In an exemplary case of the electrical apparatus 100 serving as an IH cooker, the maximum power consumption Pₘₐₓ and the minimum power consumption Pₘᵢₙ are respectively defined using Expressions (2) and (3) below, where P_{Low, Nominal} indicates the averaged power consumption in an operation state of low output.

Pₘᵢₙ=P_{Low, Nominal}×0.95 (2)

Pₘₐₓ=P_{Low, Nominal}×1.05 (3)

Also, the maximum power consumption Pₘₐₓ and the minimum power consumption Pₘᵢₙ are respectively defined using Expressions (4) and (5) below, where P_{High, Nominal} indicates the averaged power consumption in an operation state of high output.

Pₘᵢₙ=P_{High, Nominal}×0.95 (4 )

Pₘₐₓ=P_{High, Nominal}×1.05 (5 )

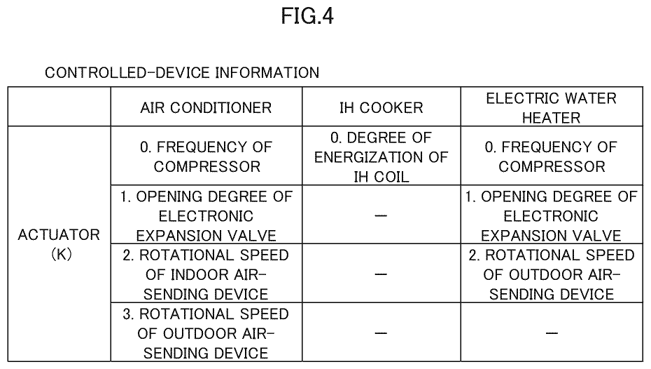

The operation amount limit acquirer 105 acquires the upper and lower limits of the amounts of operation for the actuators to be controlled, on the basis of the power consumption index calculated by the power consumption index calculator 104. As illustrated in FIG. 4, in an exemplary case of the electrical apparatus 100 serving as an air conditioner, the operation amount limit acquirer 105 acquires the upper and lower limits of the respective amounts of operation for controlling the frequency of a compressor, the opening degree of an electronic expansion valve, the rotational speed of an indoor air-sending device, and the rotational speed of an outdoor air-sending device. In another exemplary case of the electrical apparatus 100 serving as an IH cooker, the operation amount limit acquirer 105 acquires the upper and lower limits of the amount of operation for controlling the degree of energization of an IH coil. In another exemplary case of the electrical apparatus 100 serving as a water heater, the operation amount determiner 106 acquires the upper and lower limits of the respective amounts of operation for controlling the frequency of a compressor, the opening degree of an electronic expansion valve, and the rotational speed of an outdoor air-sending device.

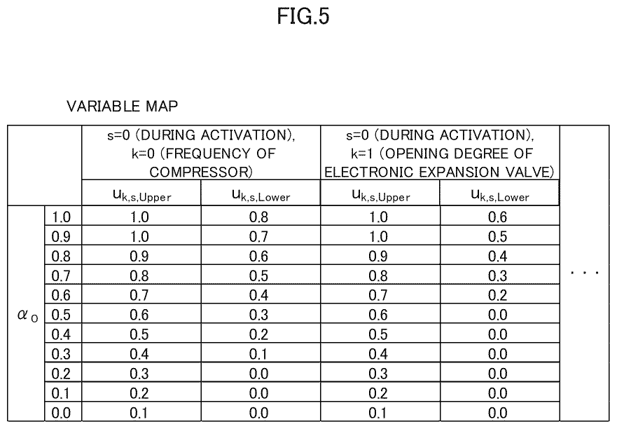

The operation amount limit acquirer 105 acquires the upper limit u_{k, s, Upper} and the lower limit u_{k, s, Lower} of the amount of operation for each actuator k, with reference to a variable map illustrated in FIG. 5. The variable map defines the upper limit u_{k, s, Upper} and the lower limit u_{k, s, Lower} of the amount of operation for each actuator k, for each power consumption index α₀ calculated by the power consumption index calculator 104 and for each operation state s of the electrical apparatus 100. The upper limit u_{k, s, Upper} and the lower limit u_{k, s, Lower} of the amounts of operation defined in the variable map are each a value of the amount of operation for the actuator k normalized to a range of 0 to 1. As illustrated in the figure, in an exemplary case where the electrical apparatus 100 is an air conditioner during activation (s=0) and the power consumption index α₀ calculated by the power consumption index calculator 104 is 0.6, the variable map provides 0.7 as the upper limit of the amount of operation for a variable compressor (k=0) and 0.4 as the lower limit. The variable map is an example of operation amount range information.

Referring back to FIG. 2, the operation amount determiner 106 determines the amounts of operation for the individual actuators k to be controlled. Specifically, the operation amount determiner 106 calculates amounts of operation in intervals of discrete time Δt. The description assumes that the power consumption index xᵢ(t) of the electrical apparatus 100 at a time t can be represented by a linear time-invariant system as in Expression (6) below.

Expression 1

xᵢ(t)=Axᵢ(t)+Buᵢ(t) (6)

In Expression (6), uᵢ(t) indicates a column vector indicating amounts of operation for the individual actuators k of the electrical apparatus 100, represented by Expression (7).

uᵢ(t)=[u_{i, 0}, u_{i, 1}, u_{i, 2}, . . . , u_{i, n-1}]^{T} (7)

In Expression (6), A indicates a scalar coefficient, and B indicates an n×1 vector.

The power consumption index xᵢ(t) of the electrical apparatus 100 at a time t and the power consumption index xⱼ(t) of each of the other electrical apparatuses 100 communicably connected to the electrical apparatus 100 at the time t are respectively represented by Expressions (8) and (9) below, where αᵢ indicates a power consumption index of the electrical apparatus 100 and αⱼ indicates a power consumption index of the other electrical apparatus 100 at the time t.

xᵢ(t)=αᵢ (8)

xⱼ(t)=αⱼ (9)

The operation amount determiner 106 of the electrical apparatus 100 compares the power consumption index αᵢ of the electrical apparatus 100 with the power consumption indexes αⱼ of the other electrical apparatuses 100. When determining that any of the other electrical apparatuses 100 satisfies the inequation αᵢ>αⱼ, the operation amount determiner 106 calculates amounts uᵢ(t) of operation for the individual actuators k using Expression (10) below.

Expression 2

uᵢ(t)=−KΣ_{j∈agents connected to i}(xᵢ(t)−xⱼ(t) (10)

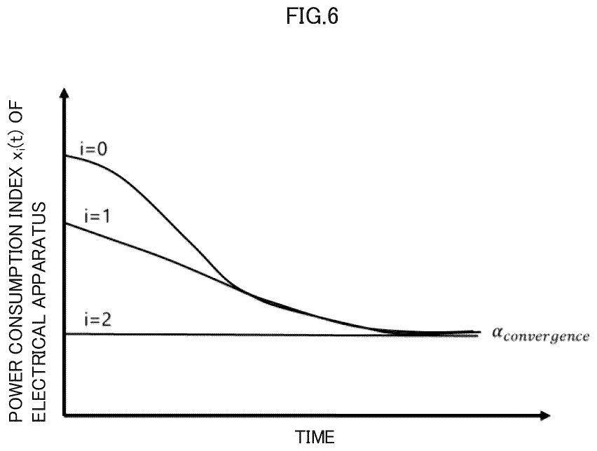

In Expression (10), K is any 1×n vector. As illustrated in FIG. 6, Expression (10) represents a consensus algorithm that performs consensus control to converge the power consumption indexes xᵢ(t) of the electrical apparatuses 100 (i=0, 1, 2) to a common value α_{convergence}.

The operation amount determiner 106 then compares the amount u_{i, k}(t) of operation for each actuator k calculated using Expression (10) with the upper limit u_{i, k, Upper} and the lower limit u_{i, k, Lower} of the amount of operation for each actuator k acquired by the operation amount limit acquirer 105. The operation amount determiner 106 determines the amount u_{i, k}(t) to be the upper limit u_{k, s, Upper}, when the amount u_{i, k}(t) is larger than the upper limit u_{k, s, Upper}. The operation amount determiner 106 determines the amount u_{i, k}(t) to be the lower limit u_{i, k, Lower}, when the amount u_{i, k}(t) is smaller than the lower limit u_{i, k, Lower}.

In contrast, when the operation amount determiner 106 compares the power consumption index αᵢ of the electrical apparatus 100 with the power consumption indexes αⱼ of the other electrical apparatuses 100 and determines that none of the other electrical apparatuses 100 satisfies the inequation αᵢ>αⱼ, the operation amount determiner 106 determines the previous amounts of operation uᵢ(t−Δt) to be the applied amounts of operation, using Expression (11) below.

uᵢ(t)=uᵢ(t−Δt) (11)

When none of the other electrical apparatuses 100 is determined to satisfy the inequation αᵢ>αⱼ, the amounts u (t) of operation that minimize the cost function J(x(t) containing the power consumption index x(t) may be applied using the model predictive control represented by Expression (12) below, instead of Expression (11). This modification can lower the power consumption index of the electrical apparatus 100, thereby possibly reducing the overall power consumptions of the network more rapidly.

uᵢ(t)=minJ(x(t)) (12)

The operation amount determiner 106 is an example of an operation amount calculator.

Referring back to FIG. 2, the operation controller 107 controls the operation of the actuators k of the electrical apparatus 100, on the basis of the amounts of operation determined by the operation amount determiner 106.

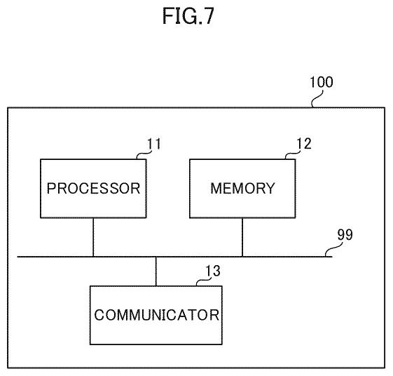

As illustrated in FIG. 7, the electrical apparatus 100 having the above-described functional components includes, as physical components, a processor 11 that executes processes in accordance with programs, a memory 12 that stores various programs, and a communicator 13 that transmits and receives information. These components are connected to each other via internal buses 99.

The processor 11 reads and executes the programs stored in the memory 12. The processor 11 includes any of various processing units, such as central processing units (CPUs) and micro-processing units (MPUs), for example. The processor 11 executes, as main functions provided from the programs, the processes of the power consumption acquirer 102, the operation state identifier 103, the power consumption index calculator 104, the operation amount limit acquirer 105, the operation amount determiner 106, and the operation controller 107.

The memory 12 includes a memory device, such as read only memory (ROM) or random access memory (RAM). The memory 12 preliminarily stores a control program, and stores the variable map illustrated in FIG. 5.

The communicator 13 is a communication interface for wireless communication pursuant to a wireless communication standard, such as WiFi, Bluetooth (registered trademark), or ZigBee (registered trademark), for example. The communicator 13 is communicably connected to a wireless network established in the house H, and communicates with the other electrical apparatuses 100 via the wireless network. The communicator 13 functions as the communicator 101 and the power consumption acquirer 102.

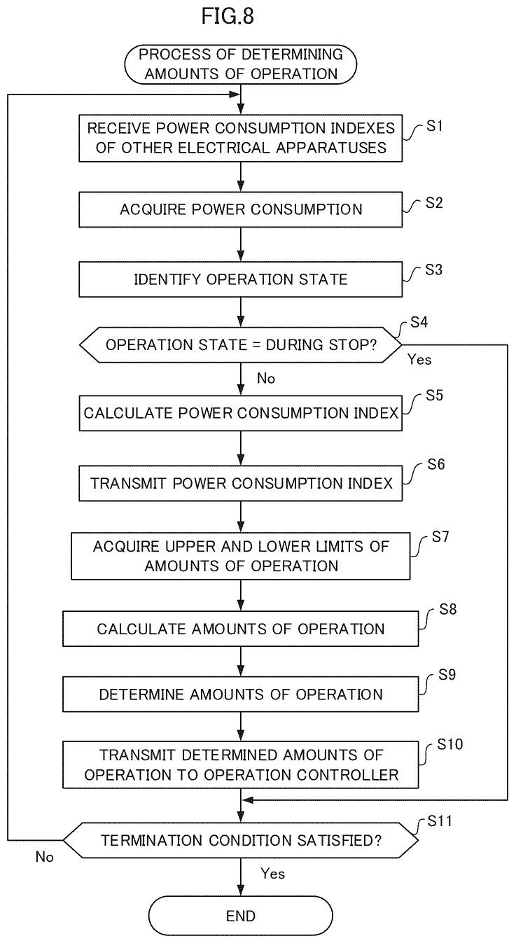

The following describes the operation of the electrical apparatus 100, with reference to FIG. 8. The electrical apparatus 100 is connected to the other electrical apparatuses 100 via the network so as to communicate with the other electrical apparatuses 100. Each of the electrical apparatuses 100 acquires the detected value of the power consumption of the electrical apparatus 100 at certain intervals, calculates a power consumption index indicating a normalized value of the acquired power consumption, and transmits the calculated power consumption index to the other electrical apparatuses 100 capable of communication. The electrical apparatus 100 determines the amounts of operation for the actuators k included in the electrical apparatus 100 in accordance with the predetermined consensus algorithm, and controls the actuators k on the basis of the determined amounts of operation. The following description focuses on an example in which the electrical apparatus 100a is communicably connected to the electrical apparatuses 100b and 100c and calculates amounts of operation.

When the electrical apparatus 100a is powered on by a user, the electrical apparatus 100a initiates the process.

The communicator 101 of the electrical apparatus 100a receives the power consumption indexes indicating normalized values of the power consumptions of the other electrical apparatuses 100b and 100c, from the electrical apparatuses 100b and 100c at predetermined time intervals (Step S1).

The power consumption acquirer 102 then acquires the power consumption of the electrical apparatus 100a (Step S2). Specifically, the electrical apparatus 100a acquires, from the current transformer CT1, the detected value of the electric power P1 fed from the distribution board 400 to the electrical apparatus 100a.

The operation state identifier 103 then identifies the operation state of the electrical apparatus 100a (Step S3). Specifically, the operation state identifier 103 identifies the current state of the electrical apparatus 100a, from among the operation states defined in the operation state information illustrated in FIG. 3, pursuant to the predetermined rules.

In an exemplary case of the electrical apparatus 100a serving as an air conditioner, the operation state identifier 103 calculates the difference between the temperature preset by the user through remote control and the temperature detected by a temperature sensor installed in the electrical apparatus 100a. When the calculated temperature difference is at least a predetermined threshold, the operation state identifier 103 identifies the electrical apparatus 100a to be during activation. In contrast, when the temperature difference is smaller than the threshold, the operation state identifier 103 identifies the electrical apparatus 100a to be during stable operation. When the temperature is not preset, the operation state identifier 103 identifies the electrical apparatus 100a to be during stop.

In another exemplary case where the electrical apparatus 100a is an IH cooker and preset heating power information indicates a value of at least a predetermined value, the operation state identifier 103 identifies the electrical apparatus 100a to be during high output. In contrast, for preset heating power information indicating a value lower than the predetermined value, the operation state identifier 103 identifies the electrical apparatus 100a to be during low output. For no preset heating power information, the operation state identifier 103 identifies the electrical apparatus 100a to be during stop.

In another exemplary case of the electrical apparatus 100a serving as an electric water heater, the operation state identifier 103 monitors the time of water heating scheduled by the user. The operation state identifier 103 identifies the electrical apparatus 100a to be during water heating in the scheduled time of water heating, and identifies the electrical apparatus 100a to be during stop in the other situations.

When the operation state of the electrical apparatus 100a is identified to be not during stop (Step S4; No), the process goes to S5, in which the power consumption index calculator 104 calculates a power consumption index of the electrical apparatus 100a (Step S5). Specifically, the power consumption index calculator 104 calculates a power consumption index indicating the power consumption normalized to a range of 0 to 1, on the basis of the operation state of the electrical apparatus 100 a identified by the operation state identifier 103. The power consumption index calculator 104 calculates a power consumption index using the power consumption index function f_{power consumption index function}(state) represented by Expression (1) above, for obtaining a power consumption index on the basis of the operation state identified in Step S3 and the maximum power consumption Pₘₐₓ and the minimum power consumption Pₘᵢₙ predetermined for each type of electrical apparatus 100 and for each operation state.

The power consumption index calculator 104 then transmits the power consumption index of the electrical apparatus 100a calculated in Step S5, via the communicator 101 to the other electrical apparatuses 100b and 100c (Step S6).

The operation amount limit acquirer 105 then acquires the upper and lower limits of the amounts of operation for the actuators k included in the electrical apparatus 100a, on the basis of the operation state identified in Step S3 and the power consumption index calculated in Step S5 (Step S7). Specifically, the operation amount limit acquirer 105 acquires the upper and lower limits of the amounts of operation, with reference to the variable map illustrated in FIG. 5 preliminarily stored in the memory 12. In an exemplary case of the electrical apparatus 100a serving as an air conditioner, the operation state identified in Step S3 indicates during activation (s=0), and the power consumption index α₀ calculated in Step S5 is 0.6, then the operation amount limit acquirer 105 acquires 0.7 as the upper limit of the amount of operation for the compressor and 0.4 as the lower limit. The operation amount limit acquirer 105 acquires the upper and lower limits of the amounts of operation for the individual actuators k to be controlled, and outputs the acquired upper and lower limits to the operation amount determiner 106.

The operation amount determiner 106 then calculates amounts of operation for the actuators k included in the electrical apparatus 100a (Step S8). Specifically, the operation amount determiner 106 compares the power consumption index αᵢ of the electrical apparatus 100a calculated in Step S5 with the power consumption indexes αⱼ of the other electrical apparatuses 100b and 100c received in Step S1, and determines whether either of the other electrical apparatuses 100b and 100c satisfies the inequation αᵢ>αⱼ.

When determining that either of the other electrical apparatuses 100b and 100c satisfies the inequation αᵢ>αⱼ, the operation amount determiner 106 calculates a column vector uᵢ(t) indicating amounts of operation for the individual actuators k of the electrical apparatus 100a, in accordance with the consensus algorithm represented by Expression (10) above.

The operation amount determiner 106 then determines the amounts of operation for the individual actuators k (Step S9). Specifically, the operation amount determiner 106 compares the amount u_{i, k}(t) of operation for each actuator k calculated using Expression (10) with the upper limit u_{i, k, Upper} and the lower limit u_{i, k, Lower} of the amount of operation for each actuator k acquired in Step S7. The operation amount determiner 106 determines the amount u_{i, k}(t) of operation for each actuator k to be the upper limit u_{i, k, Upper} when the amount u_{i, k}(t) is larger than the upper limit u_{i, k, Upper}, determines the amount u_{i, k}(t) to be the lower limit u_{i, k, Lower} when the amount u_{i, k}(t) is smaller than the lower limit u_{i, k, Lower}, and determines the calculated amount u_{i, k}(t) to be the applied amount of operation.

In contrast, when the operation amount determiner 106 compares the power consumption index αᵢ of the electrical apparatus 100a with the power consumption indexes aⱼ of the other electrical apparatuses 100b and 100c and determines that neither of the other electrical apparatuses 100b and 100c satisfies the inequation αᵢ>αⱼ, the operation amount determiner 106 determines the previous amounts of operation uᵢ(t−Δt) to be the applied amounts of operation, using Expression (11) or (12) above.

The operation amount determiner 106 then outputs the amounts of operation for the individual actuators k determined in Step S9, to the operation controller 107 (Step S10). The operation controller 107 controls the operation of the individual actuators k, on the basis of the output amounts of operation.

The operation amount determiner 106 then determines whether the current situation satisfies any of the termination conditions for concluding the process of determining amounts of operation (Step S11). The termination conditions include, for example, a condition of exceedance of the period of the process of determining amounts of operation exceeds a predetermined time, and a condition of transmission of an instruction signal for terminating the process of determining amounts of operation from the user. When determining that the current situation does not satisfy any of the termination conditions (Step S11; No), the operation amount determiner 106 returns to Step S1, followed by repetition of the process of determining amounts of operation. In contrast, when determining that the current situation satisfies any of the termination conditions (Step S11; Yes), the operation amount determiner 106 terminates the process. The repetition of the process of determining amounts of operation in accordance with the consensus algorithm causes the power consumption indexes of the individual electrical apparatuses 100 to gradually converge to a convergence value α_{convergence}.

Referring back to Step S4, when the operation state identifier 103 identifies the electrical apparatus 100a to be during stop (Step S4; Yes), the process goes to Step S11 involving determination of satisfaction of any of the termination conditions.

As described above, when the power consumption index indicating a normalized value of the power consumption of the electrical apparatus 100 is higher than the power consumption indexes of the other electrical apparatuses 100, the electrical apparatus 100 calculates amounts of operation for the devices to be controlled included in the electrical apparatus 100 on the basis of the difference between the own power consumption index and the power consumption indexes of the other electrical apparatuses 100. The electrical apparatus 100 then controls the operation of the actuators k to be controlled on the basis of the calculated amounts of operation. This system can achieve reduced power consumptions without an additional dedicated control apparatus.

The amounts of operation are calculated using the power consumption indexes indicating normalized values of the power consumptions. This calculation can set a common target value of power consumption among different types of electrical apparatuses 100.

The variable map defines the range of amount of operation for each operation state and for each power consumption index, and thus contributes to a reduction in power consumptions of the electrical apparatuses 100 without impairing the comfort and convenience of the user.

### Embodiment 2

An electrical apparatus 100A according to Embodiment 2 determines the amounts of operation for actuators k included in the electrical apparatus 100A, on the basis of not only the power consumption but also a comfort index indicating a degree of comfort of the user.

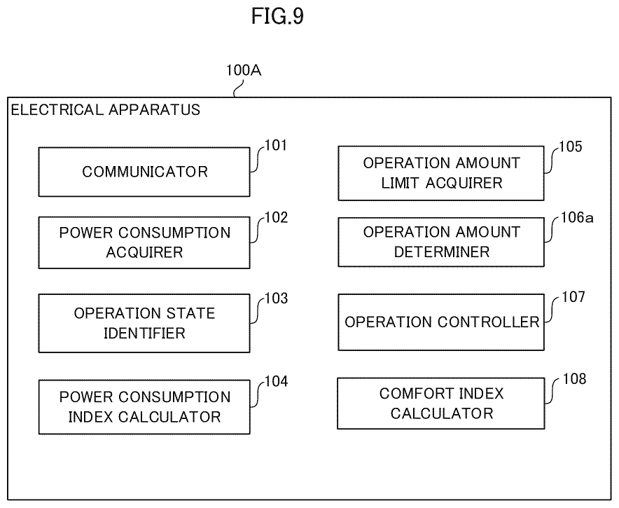

As illustrated in FIG. 9, the electrical apparatus 100A includes the communicator 101, the power consumption acquirer 102, the operation state identifier 103, the power consumption index calculator 104, the operation amount limit acquirer 105, and the operation controller 107, like the electrical apparatus 100. The electrical apparatus 100A also includes a comfort index calculator 108 that calculates a comfort index of the user, and an operation amount determiner 106a that determines the amounts of operation for the actuators k on the basis of the power consumption index calculated by the power consumption index calculator 104 and the comfort index calculated by the comfort index calculator 108, in place of the operation amount determiner 106 of the electrical apparatus 100.

The comfort index calculator 108 calculates a comfort index indicating a degree of comfort of the user. The comfort index is a value on the same scale as the power consumption index, for example, a value ranging from 0 to 1. In an exemplary case of the electrical apparatus 100A serving as an air conditioner, the comfort index calculator 108 calculates a comfort index using a thermal comfort index, such as standard effective temperature (SET*), for example. Specifically, the comfort index calculator 108 obtains an estimated value of sensory temperature on the basis of the average between the wall surface temperature and the air temperature in an indoor space or the average between the floor surface temperature and the air temperature. The comfort index calculator 108 sets the comfort index to 1.0 when the obtained sensory temperature is 25 °C, and calculates a comfort index pursuant to a rule that decreases the comfort index by 0.1 for each 0.1 °C deviation of the sensory temperature from 25 °C, for example. In another exemplary case of the electrical apparatus 100A serving as a cooker, such as IH cooker, the comfort index calculator 108 calculates a comfort index on the basis of the difference between the preset temperature designated by the user and the value detected by a thermostat. In another exemplary case of the electrical apparatus 100A serving as a water heater, the comfort index calculator 108 calculates a comfort index on the basis of the difference between the volume of reserved hot water and a predetermined threshold.

The operation amount determiner 106a determines the amounts of operation for the actuators k, on the basis of the power consumption index and the comfort index. Specifically, the operation amount determiner 106a calculates amounts of operation in intervals of discrete time Δt. The vector value xᵢ(t) indicating the power consumption index αⱼ and the comfort index βᵢ of the electrical apparatus 100A at the time t is represented by Expression (13) below.

xᵢ(t)=[αᵢ, βᵢ]^{T} (13)

The description assumes that the vector value xᵢ(t) can be represented by a linear time-invariant system as in Expression (14) below.

Expression 3

xᵢ(t)=Aᵢxᵢ(t)+Buᵢ(t) (14)

In Expression (14), uᵢ(t) is a column vector indicating amounts of operation for the individual actuators k of the electrical apparatus 100A, represented by Expression (15).

uᵢ(t)=[u_{i, 0}, u_{i, 1}, u_{i, 2}, . . . , u_{i, k-1}]^{T} (15)

In Expression (14), Aᵢ indicates a 2×1 vector, and B indicates an n×1 vector.

The vector value xᵢ(t) of the electrical apparatus 100A at the time t and the vector value xⱼ(t) of each of the other electrical apparatuses 100A communicably connected to the electrical apparatus 100A at the time t are respectively represented by Expressions (16) and (17) below, where αᵢ indicates a power consumption index of the electrical apparatus 100A, αⱼ indicates a power consumption index of the other electrical apparatus 100A communicably connected to the electrical apparatus 100A, βᵢ indicates a comfort index of the electrical apparatus 100A, and βⱼ indicates a comfort index of the other electrical apparatus 100A at the time t.

xᵢ(t)=[αᵢ, βᵢ]^{T} (16)

xⱼ(t)=[αⱼ, βⱼ]^{T} (17)

The operation amount determiner 106a compares the power consumption index αᵢ and the comfort index βᵢ of the electrical apparatus 100A with the power consumption indexes αᵢ and the comfort indexes βⱼ of the other electrical apparatuses 100A, respectively. When determining that any of the other electrical apparatuses 100A satisfies the inequation βᵢ>αⱼ or βᵢ<βⱼ, the operation amount determiner 106a calculates amounts uᵢ(t) of operation for the actuators k, using Expression (18) below representing a consensus algorithm.

Expression 4

uᵢ(t)=−KΣ_{j∈agents connected to i}(xᵢ(t)−xⱼ(t)) (18)

In Expression (18), K indicates a 2×n vector.

In contrast, when determining that none of the other electrical apparatuses 100A satisfies the inequation βᵢ>αⱼ or βᵢ<βⱼ, the operation amount determiner 106a calculates the previous amounts uᵢ(t−Δt) of operation using Expression (11) or (12) above, like the operation amount determiner 106.

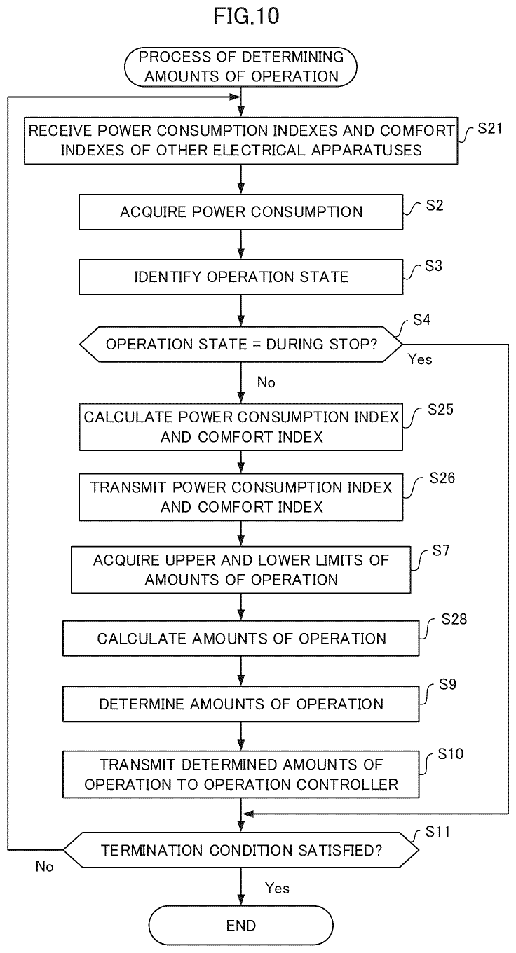

The following describes the process of determining amounts of operation executed by the electrical apparatus 100A, with reference to FIG. 10. The description focuses on the differences between the flowchart illustrated in FIG. 10 and the flowchart illustrated in FIG. 8, because these flowcharts involve some common steps.

In Step S21, the communicator 101 receives the power consumption indexes and the comfort indexes of the other electrical apparatuses 100A, from the other electrical apparatuses 100A at predetermined time intervals.

In Step S25, the power consumption index calculator 104 calculates a power consumption index indicating the power consumption normalized to a range of 0 to 1, on the basis of the operation state of the electrical apparatus 100A identified by the operation state identifier 103, as in Step S5. The comfort index calculator 108 calculates a comfort index indicating a degree of comfort of the user. Specifically, the comfort index calculator 108 calculates a comfort index, pursuant to the rules for calculation of comfort indexes predetermined depending on the type of the electrical apparatus 100A.

The power consumption index calculator 104 then transmits the power consumption index and the comfort index calculated in Step S25, via the communicator 101 to the other electrical apparatuses 100A (Step S26).

In Step S28, the operation amount determiner 106a calculates amounts of operation for the actuators k included in the electrical apparatus 100A. Specifically, the operation amount determiner 106a compares the power consumption index αⱼ and the comfort index βᵢ of the electrical apparatus 100A calculated in Step S25 with the power consumption indexes αᵢ and the comfort indexes βⱼ of the other electrical apparatuses 100A, respectively, and determines whether any of the other electrical apparatuses 100A satisfies the inequation βᵢ>αⱼ or βᵢ<βⱼ.

When determining that any of the other electrical apparatuses 100A satisfies the inequation βᵢ>αⱼ or βᵢ<βⱼ, the operation amount determiner 106a calculates a column vector uᵢ(t) indicating amounts of operation for the actuators k of the electrical apparatus 100A in accordance with the consensus algorithm represented by Expression (18) above.

As described above, the electrical apparatus 100A can determine the amounts of operation on the basis of not only the power consumption but also the comfort of the user.

### Modification 1

The power consumption reduction system 1 in Embodiment 1 may further include an operation terminal that controls the convergence value α_{convergence} to which the power consumption indexes converge in accordance with the consensus algorithm. Examples of the operation terminal include portable devices, such as smartphones, tablets, remote controls, cellular phones, and laptops. The operation terminal includes an inputter, such as push button, touch panel, or touchpad, a display, such as organic electroluminescence (EL) display or liquid crystal display, and a communication interface. The operation terminal communicates with the electrical apparatuses 100, pursuant to a well-known communication standard. When the user specifies the electrical apparatus 100 to be controlled, the operation terminal receives a target power consumption index, and transmits the received target power consumption index to the electrical apparatus 100.

The electrical apparatus 100, receiving the target power consumption index, calculates amounts of operation for the actuators k of the electrical apparatus 100, by applying the power consumption indexes oj received from the other electrical apparatuses 100 and the target power consumption index to a consensus algorithm. Applying a sufficiently low target power consumption index can reduce the overall power consumptions of the power consumption reduction system 1.

### Modification 2

The operation terminal in Modification 1 may be provided with the target power consumption index by being controlled by an external agent, such as electric power provider or electricity trading market, via the Internet, rather than by the user. This modification enables external control of demand response in an electric power grid without the mediation of a server, such as HEMS.

### Modification 3

The power consumption reduction system 1 in Embodiment 1 described above may further include a communication apparatus that mediates communications among the electrical apparatuses 100a, 100b, 100c, . . . . The communication apparatus includes a predetermined communication interface, and is connected to the wireless network established in the house H so as to be capable of wired or wireless communication. The communication apparatus communicates with the individual electrical apparatuses 100a, 100b, 100c, . . . via the wireless network, and transmits the power consumption index of the electrical apparatus 100a to the other electrical apparatuses 100b and 100c, . . . , for example. The communication apparatus thus enables transmission and reception of information, regardless of any electrical apparatus 100 incapable of direct communication included in the power consumption reduction system 1.

### Modification 4

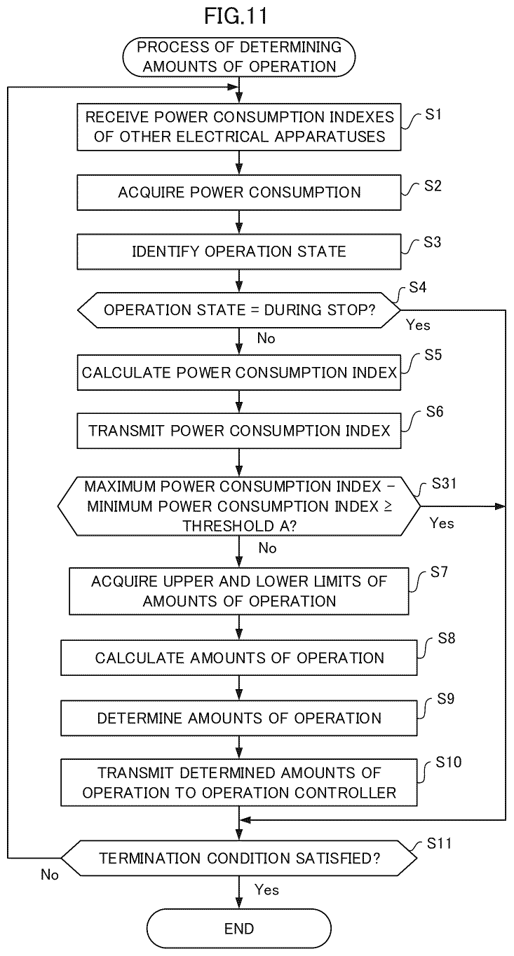

The electrical apparatuses 100a, 100b, 100c, . . . may stop the process of calculating amounts of operation and controlling the operation of the actuators k on the basis of the calculated amounts of operation, when determining that the current situation satisfies a predetermined condition. Specifically, the electrical apparatuses 100a, 100b, 100c, . . . in this modification stop the process when determining that the difference between the maximum and minimum values of the power consumption index in a predetermined duration T is at least a predetermined threshold. As illustrated in FIG. 11, each of the electrical apparatuses 100a, 100b, 100c, . . . executes the steps identical to Steps S1 to S6 executed by the electrical apparatus 100. The power consumption index calculator 104 of each of the electrical apparatuses 100a, 100b, 100c, . . . then acquires the current time from a timer included in each of the electrical apparatuses 100a, 100b, 100c, . . . , and calculates the preceding time that is a predetermined duration T before the current time, in Step S31. The power consumption index calculator 104 then determines whether the difference between the maximum value αₘₐₓ and the minimum value αₘᵢₙ of the power consumption index in the period from the calculated preceding time until the current time is at least a threshold A (Step S31). When the power consumption index calculator 104 determines that the difference between the maximum value αₘₐₓ and the minimum value αₘᵢₙ is at least the threshold A (Step S31; Yes), the process goes to Step S11 involving determination of satisfaction of any of the termination conditions (Step S11). In contrast, when the power consumption index calculator 104 determines that the difference between the maximum value αₘₐₓ and the minimum value αₘᵢₙ is smaller than the threshold A (Step S31; No), the process goes to the steps identical to Steps S7 to S11 executed by the electrical apparatus 100.

Alternatively, the electrical apparatuses 100a, 100b, 100c, . . . may calculate the difference between the maximum and minimum values of the comfort index as well as the power consumption index, and stop the process when either of the difference between the maximum and minimum values of the power consumption index and the difference between the maximum and minimum values of the comfort index is at least a predetermined threshold. The determination in Step S31 may be executed after elapse of a predetermined period T₀ from the start of the process of determining amounts of operation. When the difference between the maximum value αₘₐₓ and the minimum value αₘᵢₙ is determined to be at least the threshold A in Step S31 (Step S31; Yes), each of the electrical apparatuses 100a, 100b, 100c, . . . may terminate the process of determining amounts of operation. In this modification, if the electrical apparatus 100a terminates the process of determining amounts of operation, for example, the power consumption indexes are expected to more readily converge to the convergence value α_{convergence} because the electrical apparatuses 100b, 100c, . . . other than the electrical apparatus 100a exhibiting large variations in power consumption index continue the process of determining amounts of operation. The electrical apparatus 100a that has terminated the process of determining amounts of operation may serve as a communication apparatus that mediates communications among the other electrical apparatuses 100b, 100c, . . . . The power consumption index calculator 104 is an example of the determiner.

The description of the above-described embodiments assumes the house H as an exemplary place of power consumption. The place of power consumption is not necessarily a general house like the house H, and may also be any place, such as apartment, condominium, facility, building, or factory, provided that the place includes multiple electrical apparatuses 100 that are fed with electric power from the commercial power grid 300 and consume the electric power.

Although the electrical apparatuses 100a, 100b, 100c, . . . in the above-described embodiments transmit and receive power consumption indexes bidirectionally, this configuration is not to be construed as limiting the scope of the present disclosure. Each pair of electrical apparatuses 100 may communicate with each other bidirectionally or unidirectionally.

Although the operation amount determiner 106 calculates amounts uᵢ(t) of operation for the individual actuators k in accordance with the consensus algorithm represented by Expression (10) in the above-described embodiments, this configuration is not to be construed as limiting the scope of the present disclosure. For example, the operation amount determiner 106 may calculate amounts uᵢ(t) of operation for the individual actuators k using Expression (19) below.

uᵢ(t)=[C_{i, 0}, C_{i, 1}, . . . , C_{i, n-1}]^{T} (19)

In Expression (19), C_{i, m} indicates a predetermined constant representing the control input amount set to suppress the power consumption of each actuator k of the electrical apparatus 100. The constants C_{i, m} may also be dynamically varied depending on the difference between the own power consumption index and the power consumption indexes of the other electrical apparatuses 100, using various combinations of constants C_{i, m} prepared in advance for various differences between the own power consumption index and the power consumption indexes of the other electrical apparatuses 100, for example.

In this modification, when the operation amount determiner 106 determines that either of the other electrical apparatuses 100b and 100c satisfies the inequation αᵢ>αⱼ in Step S8 of the process of determining amounts of operation illustrated in FIG. 8, the operation amount determiner 106 may calculate a column vector uᵢ(t) indicating amounts of operation for the individual actuators k of the electrical apparatus 100a, using Expression (19) above, instead of the consensus algorithm represented by Expression (10) above.

The individual functions of the electrical apparatus 100 can be implemented by ordinary computer systems. For example, a program for executing the functions of the electrical apparatus 100 may be stored in non-transitory computer-readable recording media, such as compact disc read-only memories (CD-ROMs) and digital versatile disc read-only memories (DVD-ROMs), and distributed. The program may then be installed in a computer, so as to configure the computer that can perform the above-described functions.

In the case where these functions are achieved by sharing of an operating system (OS) and an application or by cooperation of the OS and the application, only the application may be stored in a non-transitory recording medium.

Hereinafter, various aspects of the present disclosure are recited as appendices.

(Appendix 1) A power consumption reduction system, comprising:
electrical apparatuses configured to consume electric power, wherein
each of the electrical apparatuses includes
   a power consumption acquirer to acquire a power consumption of the electrical apparatus,
   a power consumption index calculator to calculate, based on an operation state of the electrical apparatus, a power consumption index indicating a normalized value of the power consumption acquired by the power consumption acquirer,
   a transmitter to transmit, to another electrical apparatus, the power consumption index calculated by the power consumption index calculator,
   a receiver to receive a power consumption index of the other electrical apparatus,
   an operation amount calculator to calculate, based on a difference between the power consumption index calculated by the power consumption index calculator and the power consumption index received by the receiver, an amount of operation for a device to be controlled included in the electrical apparatus, when the power consumption index calculated by the power consumption index calculator is higher than the power consumption index received by the receiver, and
   an operation controller to control, based on the amount of operation calculated by the operation amount calculator, operation of the device to be controlled.

(Appendix 2) The power consumption reduction system according to appendix 1, wherein the operation amount calculator calculates, based on the difference between the power consumption index calculated by the power consumption index calculator and the power consumption index received by the receiver, the amount of operation in accordance with a predetermined consensus algorithm.

(Appendix 3) The power consumption reduction system according to appendix 1 or 2, wherein
the electrical apparatus further includes
   a storage to store operation amount range information, the operation amount range information defining an upper limit and a lower limit of the amount of operation for the device to be controlled for each operation state of the electrical apparatus and for each value of the power consumption index calculated by the power consumption index calculator, and
the operation amount calculator
   determines the upper limit to be the amount of operation for the device to be controlled, when the calculated amount of operation is larger than the upper limit, and
   determines the lower limit to be the amount of operation for the device to be controlled, when the calculated amount of operation is smaller than the lower limit.

(Appendix 4) The power consumption reduction system according to any one of appendices 1 to 3, further comprising:
an operation terminal to output a target value of the power consumption index to the electrical apparatus, wherein
the receiver further receives the target value of the power consumption index from the operation terminal, and
the operation amount calculator calculates, based on the difference between the power consumption index calculated by the power consumption index calculator and the power consumption index received by the receiver and a difference between the power consumption index calculated by the power consumption index calculator and the target value, an amount of operation for the device to be controlled included in the electrical apparatus, in accordance with a predetermined consensus algorithm.

(Appendix 5) The power consumption reduction system according to any one of appendices 1 to 4, further comprising:
a communication apparatus that mediates communications among the electrical apparatuses, wherein
the transmitter transmits the power consumption index to the other electrical apparatus via the communication apparatus, and
the receiver receives the power consumption index of the other electrical apparatus via the communication apparatus.

(Appendix 6) The power consumption reduction system according to any one of appendices 1 to 5, wherein
the electrical apparatus further includes a comfort index calculator to calculate a comfort index indicating a degree of comfort of a user,
the transmitter further transmits the comfort index calculated by the comfort index calculator to the other electrical apparatus,
the receiver further receives a comfort index of the other electrical apparatus, and
the operation amount calculator calculates, based on the difference between the power consumption index calculated by the power consumption index calculator and the power consumption index received by the receiver and a difference between the comfort index calculated by the comfort index calculator and the comfort index received by the receiver, an amount of operation for the device to be controlled included in the electrical apparatus, in accordance with a predetermined consensus algorithm.

(Appendix 7) The power consumption reduction system according to any one of appendices 1 to 6, wherein
the electrical apparatus further includes a determiner to determine whether a difference between a maximum value and a minimum value of the power consumption index calculated by the power consumption index calculator in a predetermined duration is at least a predetermined threshold, and
when the determiner determines that the difference between the maximum value and the minimum value of the power consumption index is at least the predetermined threshold, the operation amount calculator does not calculate the amount of operation.

(Appendix 8) An electrical apparatus to consume electric power, the electrical apparatus comprising:
a power consumption acquirer to acquire a power consumption of the electrical apparatus;
a power consumption index calculator to calculate, based on an operation state of the electrical apparatus, a power consumption index indicating a normalized value of the power consumption acquired by the power consumption acquirer;
a transmitter to transmit, to another electrical apparatus, the power consumption index calculated by the power consumption index calculator;
a receiver to receive a power consumption index of the other electrical apparatus;
an operation amount calculator to calculate, based on a difference between the power consumption index calculated by the power consumption index calculator and the power consumption index received by the receiver, an amount of operation for a device to be controlled included in the electrical apparatus, when the power consumption index calculated by the power consumption index calculator is higher than the power consumption index received by the receiver; and
an operation controller to control, based on the amount of operation calculated by the operation amount calculator, operation of the device to be controlled.

(Appendix 9) A method of reducing power consumption, the method comprising:
acquiring a power consumption of an electrical apparatus consuming electric power;
calculating, based on an operation state of the electrical apparatus, a power consumption index indicating a normalized value of the acquired power consumption;
transmitting, to another electrical apparatus, the calculated power consumption index;
calculating, based on a difference between the calculated power consumption index and a received power consumption index of the other electrical apparatus, an amount of operation for a device to be controlled included in the electrical apparatus, when the calculated power consumption index is higher than the received power consumption index of the other electrical apparatus; and
controlling, based on the calculated amount of operation, operation of the device to be controlled.

(Appendix 10) A program for causing a computer to:
acquire a power consumption of an electrical apparatus consuming electric power;
calculate, based on an operation state of the electrical apparatus, a power consumption index indicating a normalized value of the acquired power consumption;
transmit, to another electrical apparatus, the calculated power consumption index;
calculate, based on a difference between the calculated power consumption index and a received power consumption index of the other electrical apparatus, an amount of operation for a device to be controlled included in the electrical apparatus, when the calculated power consumption index is higher than the received power consumption index of the other electrical apparatus; and
control, based on the calculated amount of operation, operation of the device to be controlled.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No.2023-113591, filed on Jul. 11, 2023, the entire disclosure of which is incorporated by reference herein.

### REFERENCE SIGNS LIST

1 Power consumption reduction system
100, 100a, 100b, 100c, 100A Electrical apparatus
101 Communicator
102 Power consumption acquirer
103 Operation state identifier
104 Power consumption index calculator
105 Operation amount limit acquirer
106, 106a Operation amount determiner
107 Operation controller
108 Comfort index calculator
200 Network
300 Commercial power grid
400 Distribution board
11 Processor
12 Memory
13 Communicator
99 Internal bus

1. A power consumption reduction system, comprising:
electrical apparatuses configured to consume electric power, wherein each of the electrical apparatuses includes
power consumption acquiring circuitry to acquire a power consumption of the electrical apparatus,
power consumption index calculating circuitry to calculate, based on an operation state of the electrical apparatus, a power consumption index indicating a normalized value of the power consumption acquired by the power consumption acquiring circuitry,
a transmitter to transmit, to another electrical apparatus, the power consumption index calculated by the power consumption index calculating circuitry,
a receiver to receive a power consumption index of the other electrical apparatus,
operation amount calculating circuitry to calculate, based on a difference between the power consumption index calculated by the power consumption index calculating circuitry and the power consumption index received by the receiver, an amount of operation for a device to be controlled included in the electrical apparatus, when the power consumption index calculated by the power consumption index calculating circuitry is higher than the power consumption index received by the receiver, and
operation controlling circuitry to control, based on the amount of operation calculated by the operation amount calculating circuitry, operation of the device to be controlled.

2. The power consumption reduction system according to claim 1, wherein the operation amount calculating circuitry calculates, based on the difference between the power consumption index calculated by the power consumption index calculating circuitry and the power consumption index received by the receiver, the amount of operation in accordance with a predetermined consensus algorithm.

3. The power consumption reduction system according to claim 1, wherein
the electrical apparatus further includes
a storage to store operation amount range information, the operation amount range information defining an upper limit and a lower limit of the amount of operation for the device to be controlled for each operation state of the electrical apparatus and for each value of the power consumption index calculated by the power consumption index calculating circuitry, and
the operation amount calculating circuitry
determines the upper limit to be the amount of operation for the device to be controlled, when the calculated amount of operation is larger than the upper limit, and
determines the lower limit to be the amount of operation for the device to be controlled, when the calculated amount of operation is smaller than the lower limit.

4. The power consumption reduction system according to claim 1, further comprising:
an operation terminal to output a target value of the power consumption index to the electrical apparatus, wherein
the receiver further receives the target value of the power consumption index from the operation terminal, and
the operation amount calculating circuitry calculates, based on the difference between the power consumption index calculated by the power consumption index calculating circuitry and the power consumption index received by the receiver and a difference between the power consumption index calculated by the power consumption index calculating circuitry and the target value, an amount of operation for the device to be controlled included in the electrical apparatus, in accordance with a predetermined consensus algorithm.

5. The power consumption reduction system according to claim 1, further comprising:
a communication apparatus that mediates communications among the electrical apparatuses, wherein
the transmitter transmits the power consumption index to the other electrical apparatus via the communication apparatus, and
the receiver receives the power consumption index of the other electrical apparatus via the communication apparatus.

6. The power consumption reduction system according to claim 1, wherein
the electrical apparatus further includes a comfort index calculating circuitry to calculate a comfort index indicating a degree of comfort of a user,
the transmitter further transmits the comfort index calculated by the comfort index calculating circuitry to the other electrical apparatus,
the receiver further receives a comfort index of the other electrical apparatus, and
the operation amount calculating circuitry calculates, based on the difference between the power consumption index calculated by the power consumption index calculating circuitry and the power consumption index received by the receiver and a difference between the comfort index calculated by the comfort index calculating circuitry and the comfort index received by the receiver, an amount of operation for the device to be controlled included in the electrical apparatus, in accordance with a predetermined consensus algorithm.

7. The power consumption reduction system according to claim 1, wherein
the electrical apparatus further includes determining circuitry to determine whether a difference between a maximum value and a minimum value of the power consumption index calculated by the power consumption index calculating circuitry in a predetermined duration is at least a predetermined threshold, and
when the determining circuitry determines that the difference between the maximum value and the minimum value of the power consumption index is at least the predetermined threshold, the operation amount calculating circuitry does not calculate the amount of operation.

8. An electrical apparatus to consume electric power, the electrical apparatus comprising:
power consumption acquiring circuitry to acquire a power consumption of the electrical apparatus;
power consumption index calculating circuitry to calculate, based on an operation state of the electrical apparatus, a power consumption index indicating a normalized value of the power consumption acquired by the power consumption acquiring circuitry;
a transmitter to transmit, to another electrical apparatus, the power consumption index calculated by the power consumption index calculating circuitry;
a receiver to receive a power consumption index of the other electrical apparatus;
operation amount calculating circuitry to calculate, based on a difference between the power consumption index calculated by the power consumption index calculating circuitry and the power consumption index received by the receiver, an amount of operation for a device to be controlled included in the electrical apparatus, when the power consumption index calculated by the power consumption index calculating circuitry is higher than the power consumption index received by the receiver; and
operation controlling circuitry to control, based on the amount of operation calculated by the operation amount calculating circuitry, operation of the device to be controlled.

9. A method of reducing power consumption, the method comprising:
acquiring a power consumption of an electrical apparatus consuming electric power;
calculating, based on an operation state of the electrical apparatus, a power consumption index indicating a normalized value of the acquired power consumption;
transmitting, to another electrical apparatus, the calculated power consumption index;
calculating, based on a difference between the calculated power consumption index and a received power consumption index of the other electrical apparatus, an amount of operation for a device to be controlled included in the electrical apparatus, when the calculated power consumption index is higher than the received power consumption index of the other electrical apparatus; and
controlling, based on the calculated amount of operation, operation of the device to be controlled.

10. (canceled)
